(19) United States
(12) Patent Application Publication
(10) Pub. No.: US 2026/0141922 A1
(43) Pub. Date: May 21, 2026

(54) INFORMATION PROCESSING APPARATUS, MOVIE RECORDING APPARATUS, AND INFORMATION PROCESSING METHOD

(71) Applicant: CANON KABUSHIKI KAISHA, Tokyo (JP)

(72) Inventor: Akihisa Terami, Shiga (JP)

(21) Appl. No.: 19/366,566

(22) Filed: Oct. 23, 2025

(30) Foreign Application Priority Data
Oct. 29, 2024 (JP) 2024-189752

(51) Int. Cl. G11B 27/036; G11B 27/34

(52) U.S. Cl. CPC G11B 27/036; G11B 27/34

(57) ABSTRACT

An information processing apparatus receives a plurality of second movies from a movie recording apparatus configured to record a plurality of first movies, wherein each of the plurality of first movies corresponds to one of the plurality of second movies, and an image quality of the second movie is lower than an image quality of the first movie; generates a third movie by editing based on the received second movie; transmits information indicating a state of the editing to the movie recording apparatus; and receives the first movie transmitted from the movie recording apparatus in accordance with transmission orders determined based on the transmitted information.

### BACKGROUND

### Field of the Technology

The present disclosure relates to processing based on data obtained by capturing movies.

### Description of the Related Art

In video creation, there is a case where movies for material captured by a videographer who is at an outside site are transmitted to a movie editor who is at a broadcasting station, and the movie editor edits the movies for material to generate a new movie. As a method for passing movies for material captured by a videographer to a movie editor, a method for transmitting a movie via communication means has been widespread. However, there is a case where transmission of a movie for material of a high image quality takes time due to limitation of communication speed and the like.

International Publication No. 2015/097922 describes a video camera which transmits a low-resolution movie called a proxy movie which corresponds to a high-quality movie to a video editing apparatus used by a movie editor. Then, in International Publication No. 2015/097922, requests for transmitting high-quality movies which the movie editor has determined to require based on proxy movies are transmitted to the video camera, and the video camera transmits high-quality movies to the video editing apparatus in order based on the requests.

### SUMMARY

The information processing apparatus of the present disclosure receives a plurality of second movies from a movie recording apparatus configured to record a plurality of first movies, wherein each of the plurality of first movies corresponds to one of the plurality of second movies, and an image quality of the second movie is lower than an image quality of the first movie; generates a third movie by editing based on the received second movie; transmits information indicating a state of the editing to the movie recording apparatus; and receives the first movie transmitted from the movie recording apparatus in accordance with transmission orders determined based on the transmitted information.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an example of a configuration of an information processing system;

FIG. 2 is a diagram showing an example of hardware configurations of a movie editing apparatus and a movie recording apparatus;

FIG. 3 is a diagram for explaining a correspondence relation between high-quality movie files and proxy movie files;

FIG. 4 is a diagram showing an example of functional configurations of the movie editing apparatus and the movie recording apparatus;

FIG. 5 is a diagram showing an example of an editing information file;

FIG. 6 is a diagram showing an example of a high-quality movie transmission order list;

FIG. 7 is a flowchart for explaining movie recording processing;

FIG. 8 is a flowchart for explaining an update processing of a transmission order;

FIG. 9 is a diagram for explaining a storage state of high-quality movie files;

FIGS. 10A to 10D are diagrams showing examples of the high-quality movie transmission order list;

FIGS. 11A and 11B are diagrams showing examples of the editing information file; and

FIG. 12 is a flowchart for explaining high-quality movie file transmission processing.

### DESCRIPTION OF THE EMBODIMENTS

Hereinafter, embodiments of the technology of the present disclosure will be described in detail with reference to the attached drawings. Note that the following embodiments are not intended to limit the technology of the present disclosure according to Claims. Although a plurality of features are described in the following embodiments, all of the plurality of these features are not necessarily essential for the technology of the present disclosure, and the plurality of features may be combined as desired. Moreover, in the attached drawings, the same or similar configurations are denoted by the same reference signs, and repetitive descriptions are omitted.

### First Embodiment

In the present embodiment, an operation of an information processing system which is capable of communicating data between an apparatus of a videographer who is at a coverage site and an apparatus used by an editor at a broadcasting station in video creation in the broadcasting station or the like will be described.

### System Configuration

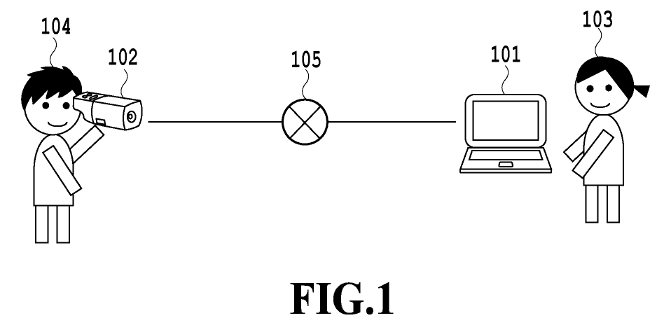

FIG. 1 is a schematic diagram showing a configuration of the information processing system of the present embodiment. The information processing system of the present embodiment includes a movie editing apparatus 101 and a movie recording apparatus 102.

The movie editing apparatus 101 is an information processing apparatus which has a movie editing function and is capable of data transmission and reception via a network or the like, such as a tablet, or a PC. The user of the movie editing apparatus 101 is an editor 103 who edits a movie.

The movie recording apparatus 102 is an information processing apparatus which is capable of movie recording by means of movie capturing and data transmission and reception via a network or the like, such as a camera, a smartphone, a tablet terminal, or a PC. The user of the movie recording apparatus 102 is a videographer 104 who is at a coverage site or the like and captures a movie. Note that although in the present embodiment, the movie recording apparatus 102 is assumed to be a device having a movie capturing function such as a camera, the movie recording apparatus 102 does not have to have a movie capturing function. For example, the movie recording apparatus 102 may be a PC connected to a camera. In this case, the movie recording apparatus 102 may be configured such that a movie file captured by the camera is recorded in a PC, which is the movie recording apparatus 102.

The movie editing apparatus 101 and the movie recording apparatus 102 are connected to be capable of communicating with each other, and are connected via a network 105 by a wireless communication, a wired communication, or the like in the present embodiment. However, the connection method is not limited.

### Hardware Configuration of Movie Editing Apparatus

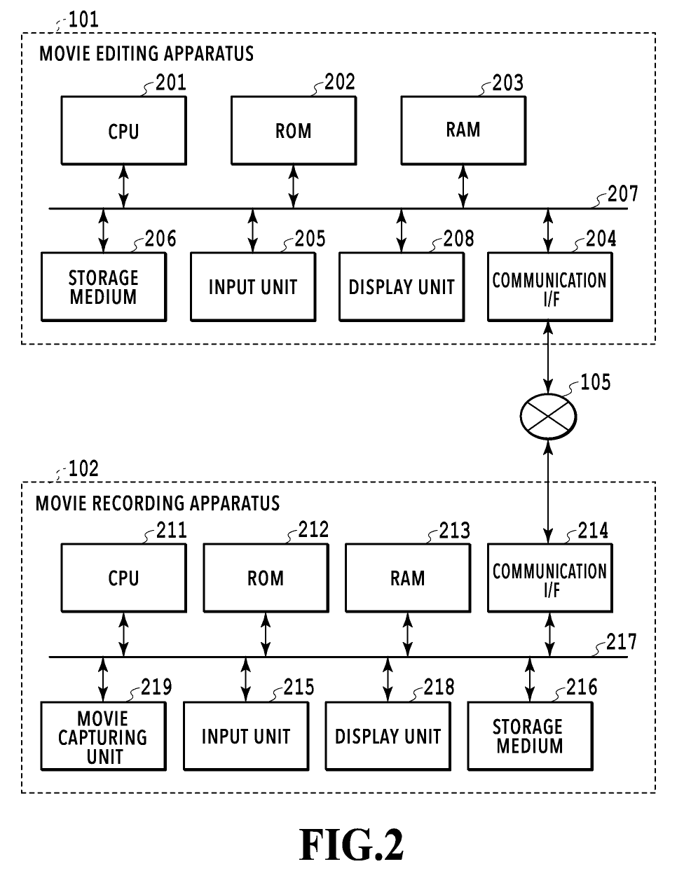

FIG. 2 is a diagram showing an example of a hardware configuration of each apparatus included in the information processing system of the present embodiment.

The movie editing apparatus 101 includes a CPU 201, a ROM 202, a RAM 203, a communication I/F 204, a storage medium 206, an input unit 205, and a display unit 208, and these constituent elements are connected via a bus 207.

The CPU 201 is a control unit which controls operations of each unit in the movie editing apparatus 101 in accordance with the content of data stored in the ROM 202 or the RAM 203. In addition, the CPU 201 loads programs stored in the ROM 202 on the RAM 203, and executes the programs.

The ROM 202 stores a boot program which is executed by the CPU 201 at the time of booting the movie editing apparatus 101, instruction programs for executing processes, data used by the programs, and the like. The storage medium 206 stores a large amount of variable data, such as a hard disk drive or a solid-state drive.

The RAM 203 is a work memory which temporarily stores programs and data for the CPU 201 to conduct the processing, and various processing programs and data are loaded on the RAM 203 by the CPU 201. In addition, information received from the movie recording apparatus 102 via the communication I/F 204 is stored in the RAM 203.

The input unit 205 is an apparatus which receives an input from a user such as a mouse or a keyboard, and the content of the input of the user thus received is processed by the CPU 201. The display unit 208 displays the content processed by the CPU 201, the content stored in the storage medium 206, and the like. The CPU 201 also operates as a display control unit which controls the display unit 208 and an input control unit which controls the input unit 205. Although the present embodiment has been described such that the display unit 208 and the input unit 205 are included in the movie editing apparatus 101, at least one of the display unit 208 and the input unit 205 may be present as another apparatus.

### Hardware Configuration of Movie Recording Apparatus

The movie recording apparatus 102 includes a CPU 211, a ROM 212, a RAM 213, a communication I/F 214, a storage medium 216, a display unit 218, and an input unit 215, and these constituent elements are connected via a bus 217.

The CPU 211 is a control unit which controls operations of each unit in the movie recording apparatus 102 in accordance with the content of data stored in the ROM 212 or the RAM 213. In addition, the CPU 211 loads programs stored in the ROM 212 on the RAM 213, and executes the programs.

The ROM 212 stores a boot program which is executed by the CPU 211 at the time of booting the movie recording apparatus 102, instruction programs for executing processes, data used by the programs, and the like.

The RAM 213 is a work memory which temporarily stores programs and data for the CPU 211 to conduct the processing, and various processing programs and data are loaded on the RAM 213 by the CPU 211. In addition, information received from the movie editing apparatus 101 via the communication I/F 214 is stored in the RAM 213.

The storage medium 216 is a recording unit such as a non-volatile device for storing variable data, and is, for example, an incorporated memory or an SD card.

The display unit 218 displays the content processed by the CPU 211, the content recorded in the storage medium 216, and the like. The input unit 215 is a device which receives an input from a user, and may be buttons included in the movie recording apparatus 102, or an apparatus such as a touch panel integrated with the display unit 218. The CPU 211 also operates as a display control unit which controls the display unit 218 and an input control unit which controls the input unit 215.

The movie capturing unit 219 is a movie capturing element configured with a CCD, a CMOS element, or the like which converts an optical image to an electrical signal.

### Proxy Movie and High-quality Movie

The videographer at the movie capturing site uses the movie recording apparatus 102 to capture a movie. As a result, in the movie recording apparatus 102, a high-quality movie file can be obtained. In the movie recording apparatus 102, a proxy movie file which is a low-quality (low-resolution) movie file whose image quality is reduced from the high-quality movie is generated from the high-quality movie file. Hence, the movie from which the proxy movie is generated is referred to as a "high-quality movie".

In the transfer of the movie files from the movie recording apparatus 102 to the movie editing apparatus 101 using a cloud server or the like, the movie recording apparatus 102 first transmits all the low-quality proxy movie files to the movie editing apparatus 101. Thereafter, the movie recording apparatus 102 transmits high-quality movie files to the movie editing apparatus 101. The editor at the broadcasting station takes the received proxy movie files into editing software included in the movie editing apparatus 101, conducts an editing work by using the proxy movie files, and generates an edited movie by using the proxy movie files.

High-quality movie files have large volumes, and take time to transmit. For this reason, by causing the movie editing apparatus 101 to receive proxy movie files first, the editor can start the editing work early. Thereafter, in the movie editing apparatus 101, when receiving high-quality movie files, a movie file of a high-quality edited movie which will eventually be used in broadcast or the like can be obtained by applying the content edited in the proxy movie files to the high-quality movie files.

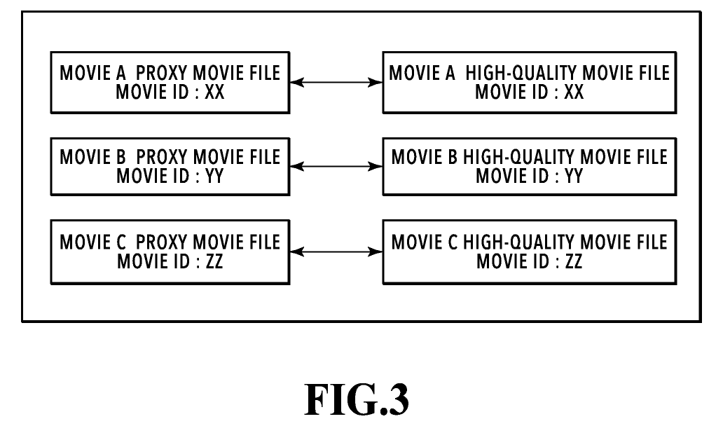

FIG. 3 is a diagram for explaining movie files obtained by the movie recording apparatus 102 capturing movies. It is assumed that a proxy movie file and a generation-source high-quality movie file are given the same value of movie ID so that the proxy movie file can be associated with the generation-source high-quality movie file. The value of movie ID is given to metadata of a proxy movie file and a high-quality movie file. Note that a method for associating a proxy movie file and the generation-source high-quality movie file is not limited to a method which gives the same ID value.

### Functional Configuration of Movie Editing Apparatus

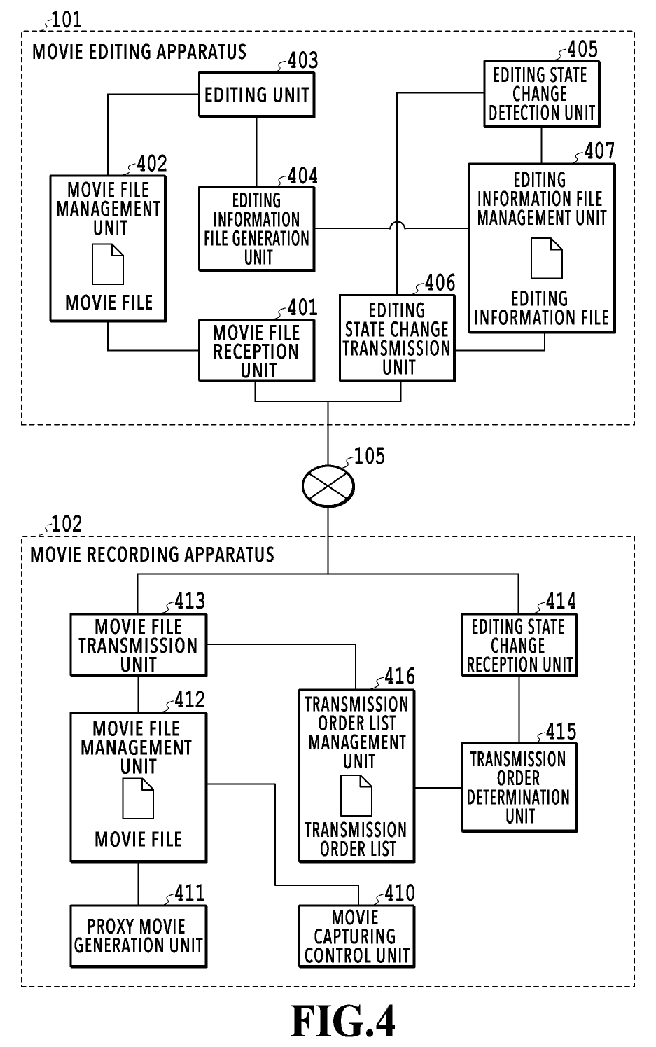

FIG. 4 is a diagram showing functional configurations and connections among the functional units of the movie editing apparatus 101 and the movie recording apparatus 102 included in the information processing system shown in FIG. 1.

The movie editing apparatus 101 includes a movie file reception unit 401, a movie file management unit 402, an editing unit 403, an editing information file management unit 407, an editing information file generation unit 404, an editing state change detection unit 405, and an editing state change transmission unit 406.

The movie file reception unit 401 receives proxy movie files transmitted from the movie recording apparatus 102.

The movie file management unit 402 stores proxy movie files received from the movie recording apparatus 102 as movie files for material in the storage medium 206 and manages the movie files.

The editing unit 403 obtains an operation of the editor via the input unit 205, and combines proxy movie files selected by the editor from among the proxy movie files managed by the movie file management unit 402 to generate an edited movie. Every time the editing unit 403 conducts editing using proxy movie files, the editing unit 403 notifies the editing information file generation unit 404 of the editing content. The editing unit 403 may notify the editing information file generation unit 404 of the editing content every predetermined period of time. The editing content indicates, for example, which proxy movie file has been added to an edited movie, what kind of processing or editing has been made on a proxy movie file, and the like.

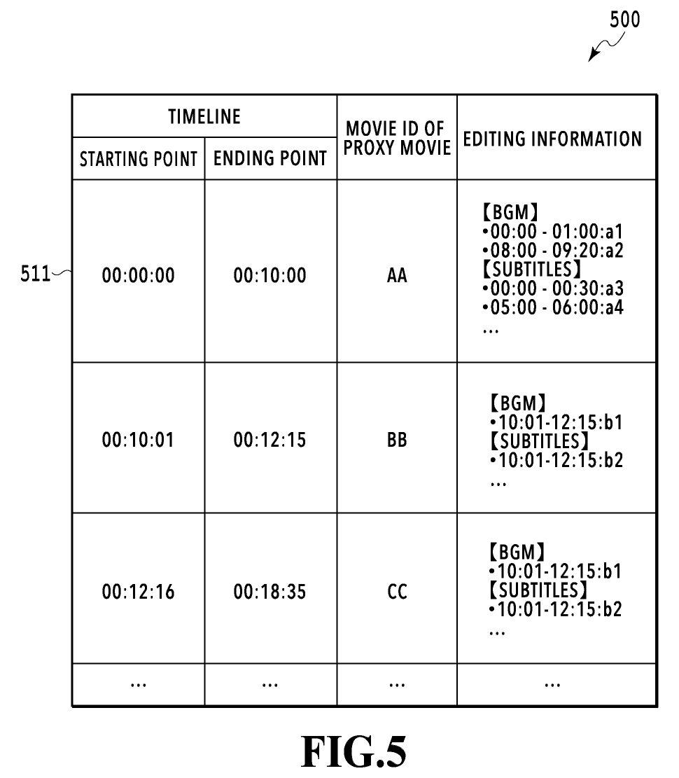

The editing information file generation unit 404 generates and updates an editing information file 500 (see FIG. 5) which indicates an editing state of an edited movie, based on the editing content received from the editing unit 403.

The editing information file management unit 407 stores the editing information file 500 in the storage medium 206 and manages the editing information file 500.

The editing state change detection unit 405 detects a change in the editing state which is conducted by the editing unit 403 from the editing information file 500, and notifies the editing state change transmission unit 406 of the type of the change in the editing state, and the value of movie ID of a proxy movie file subjected to the change in the editing state.

The editing state change transmission unit 406 transmits the type of the change in the editing state detected by the editing state change detection unit 405 and the value of movie ID to the movie recording apparatus 102.

The movie file reception unit 401 receives high-quality movie files transmitted from the movie recording apparatus 102.

Although each functional unit of the movie editing apparatus 101 shown in FIG. 4 is implemented by the CPU 201 executing a predetermined program, the configuration is not limited to this. Alternatively, for example, hardware such as a GPU (Graphics Processing Unit) for increasing the speed of computations, or an FPGA (Field Programmable Gate Array) may be used. Each functional unit may be implemented by cooperation of software and hardware such as a dedicated IC, or some or all of the functions may be implemented by only hardware.

### Edited Movie and Editing Information File

The movie editing apparatus 101 receives a plurality of proxy movie files from the movie recording apparatus 102 via the communication I/F 204. The editor cuts out parts of movies of proxy movie files which are selected from the received plurality of proxy movie files, by using editing software or the like included in the movie editing apparatus 101, and combines the cut movies to generate an edited movie.

FIG. 5 is a diagram showing an example of the editing information file 500 for managing the editing states of the target edited movies. For example, in the case where a project is newly generated, or other cases, once movie editing is newly started in the movie editing apparatus 101, an editing information file 500 is generated in the movie editing apparatus 101. That is, the editing information file 500 is generated for each edited movie. Then, once the target edited movie is edited in the movie recording apparatus 102, the editing information file 500 is updated. Once the target edited movie is completed, the editing information file 500 is deleted.

The editing information file 500 contains columns which hold values of items "Timeline", "Movie ID of the proxy movie", and "Editing information". In the editing information file 500, a value of movie ID which is an identifier indicating a used proxy movie file and editing information are held for each section on a timeline in a target edited movie being edited.

In the editing information file 500 of FIG. 5, in the column of "Movie ID of the proxy movie", values of movie ID which indicate proxy movie files used for the target edited movie are held. In the example of FIG. 5, "AA", "BB", and "CC" are held in the column of "Movie ID of the proxy movie". Hence, it can be checked that the target edited movie is generated by combining at least part of movies indicated by a proxy movie file whose movie ID is "AA", a proxy movie file whose movie ID is "BB", and a proxy movie file whose movie ID is "CC".

For example, in a row 511 in the editing information file 500 of FIG. 5, information on a section from a starting point "00:00:00" to an ending point "00:10:00" in the edited movie is held. The row 511 indicates that this section in the edited movie uses a proxy movie file whose movie ID is "AA". In the column of "Editing information", information on a BGM and subtitles used in this section are held.

In the column of "Editing information" in the row 511, information indicating that an audio file a1 is used in the section of 00:00 to 01:00, and an audio file a2 is used in the section of 08:00 to 09:20 is held in [BGM]. Audio files are stored in the storage medium 206 as files separate from the editing information file 500 in a publicly-known file format such as the WAVE format. Any number of audio files may be added.

In the column of the "Editing information" in the row 511, information indicating that a subtitles file a3 is used in the section of 00:00 to 00:30, and a subtitles file a4 is used in the section of 05:00 to 06:00 is held in [Subtitles]. The subtitles files are stored in the storage medium 206 as files separate from the editing information file 500 in a publicly-known file format such as an SRT format. Any number of subtitles files may be added. Audio and BGM are examples of information to be held in "Editing information", and the information is not limited to these. Information on a sound effect and an effect may be held in "Editing information".

Note that the description format of the editing information file 500 is not limited to the format shown in FIG. 5. The editing information file 500 may be described in a publicly-known format such as XML, or may be described in a different format.

The types of changes of the editing state which are detected by the editing state change detection unit 405 includes, for example, "Addition of movie ID", "Deletion of movie ID", and "Addition of editing information".

"Addition of movie ID" indicates that a corresponding proxy movie file has been added to an edited movie. In the case where a value of movie ID is newly held in the column of "Movie ID of the proxy movie" in the editing information file 500, the editing state change detection unit 405 detects "Addition of movie ID".

"Deletion of movie ID" indicates that a corresponding proxy movie file which was used in an edited movie has been deleted. In the case where a value of movie ID held in the column of "Movie ID of the proxy movie" in the editing information file 500 is deleted, the editing state change detection unit 405 detects "Addition of movie ID".

"Addition of editing information" indicates that information has been added to "Editing information" of a proxy movie file used in editing. In the case where the number of characters described in the column of "Editing information" in the editing information file 500 of FIG. 5 exceeds a certain value as a result of editing a proxy movie, the editing state change detection unit 405 detects "Addition of editing information". For example, in the case where an audio file has been newly added along with addition of a BGM, or in the case where a subtitles file has been newly added along with addition of subtitles, "Addition of editing information" is detected.

### Functional Configuration of Movie Recording Apparatus

As shown in FIG. 4, the movie recording apparatus 102 includes a proxy movie generation unit 411, a movie file management unit 412, a movie file transmission unit 413, an editing state change reception unit 414, a transmission order determination unit 415, a transmission order list management unit 416, and a movie capturing control unit 410.

The proxy movie generation unit 411 generates a proxy movie file from a high-quality movie file.

The movie file management unit 412 stores a high-quality movie file, which has been obtained by the movie capturing unit 219 of the movie recording apparatus 102 capturing a movie, and a proxy movie file in the storage medium 216, and manages the high-quality movie file and the proxy movie file.

The movie file transmission unit 413 transmits a proxy movie file to the movie editing apparatus 101 via the network 105.

The editing state change reception unit 414 receives information on a change in the editing state from the movie editing apparatus 101 via the network 105, and notifies the transmission order determination unit 415 of the information.

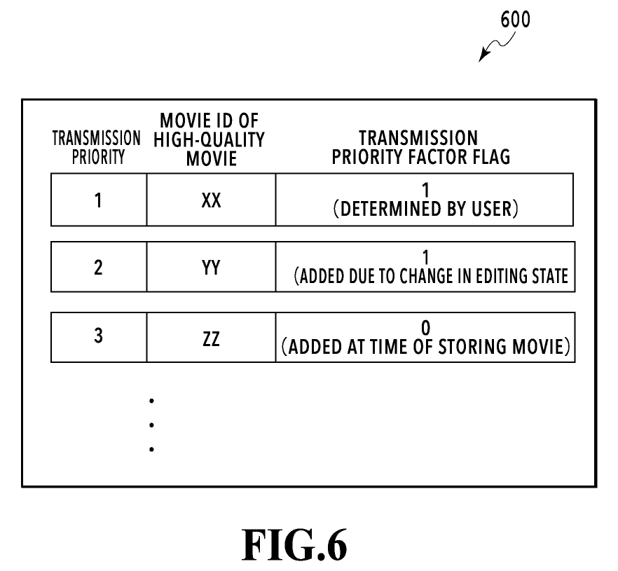

The transmission order determination unit 415 determines transmission orders of high-quality movie files based on the information on the change in the editing state in the movie editing apparatus 101, which is received by the editing state change reception unit 414, and updates the high-quality movie transmission order list 600 (see FIG. 6).

The transmission order list management unit 416 stores, in the storage medium 216, and manages the high-quality movie transmission order list 600.

The movie file transmission unit 413 refers to the high-quality movie transmission order list 600, and transmits the high-quality movie files to the movie editing apparatus 101 in numerical order of transmission priorities.

The movie capturing control unit 410 controls the movie capturing unit 219 to capture movies in order to obtain high-quality movie files.

Although each functional unit of the movie recording apparatus 102 shown in FIG. 4 is implemented by the CPU 211 executing a predetermined program, the configuration is not limited to this. Alternatively, for example, hardware such as a GPU (Graphics Processing Unit) for increasing the speed of computations, or an FPGA (Field Programmable Gate Array) may be used. Each functional unit may be implemented by cooperation of software and hardware such as a dedicated IC, or some or all of the functions may be implemented by only hardware.

### High-quality Movie Transmission Order List

FIG. 6 is a diagram showing an example of the high-quality movie transmission order list. The high-quality movie transmission order list 600 is a list in which values of a movie ID indicating a high-quality movie file to be transmitted to the movie editing apparatus 101, a transmission priority, and a transmission priority factor flag are registered.

Every time the movie file management unit 412 stores a high-quality movie file, a movie ID indicating the stored high-quality movie file is registered in the high-quality movie transmission order list 600, and a transmission priority corresponding to the movie ID is determined. The transmission priority is a number indicating the order of transmission of a high-quality movie file. The transmission priority of "1" indicates that the transmission order is the first. That is, the value of the transmission priority indicates that the smaller the numerical value is, the higher the priority is.

FIG. 6 shows a transmission order in which since the transmission priority of the high-quality movie file whose movie ID is "XX" is "1", the high-quality movie file whose movie ID is "XX" is to be first transmitted to the movie editing apparatus 101.

After the transmission of a high-quality movie file is completed, the movie ID indicating the transmitted high-quality movie file is deleted from the high-quality movie transmission order list 600, and transmission priorities of the other movie IDs are heightened by one (the numerical values of the transmission priorities of the other movie IDs are decremented by one).

In FIG. 6, the transmission priority of the high-quality movie file whose movie ID is "YY" is "2". For this reason, after the transmission of the high-quality movie file whose movie ID is "XX" and whose transmission priority is "1" is completed, the transmission priority of the high-quality movie file whose movie ID is "YY" is next updated to "1". Similarly, FIG. 6 shows a transmission order in which a high-quality movie file whose movie ID is "ZZ" and whose transmission priority is "3" will be transmitted next to the high-quality movie file whose movie ID is "YY".

In the column of "Transmission priority factor flag" of FIG. 6, a value indicating a factor for determining the "Transmission priority" is held. The value of "Transmission priority factor flag" is held to be "0" at the time of storing a high-quality movie file, for example. In the case where a change in the editing state is received from the movie editing apparatus 101, the transmission order determination unit 415 changes the value of "Transmission priority factor flag" to "1".

### Method for Determining Transmission Priority

The transmission priority indicating the transmission order of a high-quality movie file is determined by referring to "Transmission priority factor flag". Specifically, the transmission priority is determined such that a high-quality movie file whose value of "Transmission priority factor flag" is "1" is transmitted prior to a high-quality movie file whose value of "Transmission priority factor flag" is "0". For the transmission priority of a high-quality movie file whose value of "Transmission priority factor flag" is "1", the transmission priority is determined such that the high-quality movie file is transmitted by a FIFO (First In First Out) method. The FIFO method is a method in which data stored first is transmitted first. Similarly, for the transmission priority of a high-quality movie file whose value of "Transmission priority factor flag" is "0", the transmission priority is determined such that the high-quality movie file is transmitted by the FIFO method. As a result, among movie files whose values of "Transmission priority factor flag" are "1", "Transmission priority" of a movie file which is stored earliest is determined to be "1".

The editor wants to obtain high-quality movie files associated with proxy movie files used in an edited movie as soon as possible. For this reason, for movie files whose types of state change, which indicate the movie files have been used in an edited movie, are "Addition of movie ID" or "Addition of editing information", the value of "Transmission priority factor flag" is set to "1". In the case where the type of the change in the editing state is "Deletion of movie ID", the transmission priority is changed such that the transmission order becomes the lowest.

The transmission order of a high-quality movie shown by the high-quality movie transmission order list 600 may be displayed on the display unit 218 of the movie recording apparatus 102. In addition, there is a case where the user wants to transmit a specific high-quality movie file to the movie editing apparatus 101 early. For this reason, an input of a transmission order from a user may be received through the input unit 215. In this case, for example, the value of "Transmission priority factor flag" associated with the movie ID of the movie file designated by the input from the user is changed to "1". Alternatively, "Transmission priority" associated with the movie ID of the movie file designated by the input from the user may be changed to "1".

### Operation at Time of Movie Recording

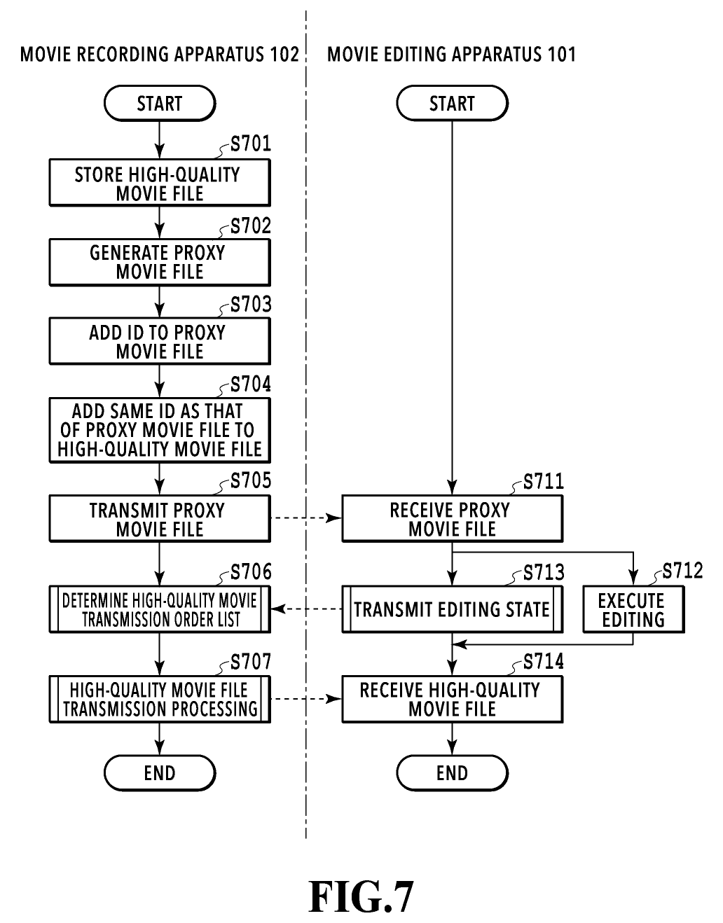

FIG. 7 is a flowchart for explaining an operation after the videographer 104 captured a movie. The processing from S701 to S707 of FIG. 7 is conducted by the CPU 211 of the movie recording apparatus 102 deploying program codes stored in the ROM 212 on the RAM 213, and executing the program codes. Alternatively, some or all of the functions of the steps in FIG. 7 may be implemented by hardware such as an ASIC or an electronic circuit. The sign "S" in the description of each processing means a step in the flowchart, and the same applies to the following flowcharts.

In S701, the movie file management unit 412 of the movie recording apparatus 102 stores (records) a movie file obtained by the movie capturing unit 219 capturing a movie as a high-quality movie file.

In S702, the proxy movie generation unit 411 generates a proxy movie file from the high-quality movie file stored in S701.

In S703, the proxy movie generation unit 411 adds a value of movie ID to metadata of the proxy movie file.

In S704, the movie file management unit 412 adds the same value of movie ID as the value of movie ID added in S703 to metadata of the high-quality movie file stored in S701.

In S705, the movie file transmission unit 413 transmits the proxy movie file to the movie editing apparatus 101.

In S706, the transmission order determination unit 415 determines a transmission order of the high-quality movie, and generates a high-quality movie transmission order list 600.

In S707, the movie file transmission unit 413 executes a high-quality movie file transmission processing. The detail will be described later.

The processing from S711 to S714 of FIG. 7 is conducted by the CPU 201 of the movie editing apparatus 101 deploying program codes stored in the ROM 202 on the RAM 203, and executing the program codes. Alternatively, some or all of the functions of the steps may be implemented by hardware such as an ASIC or an electronic circuit.

In S711, the movie file reception unit 401 receives the proxy movie file transmitted from the movie recording apparatus 102 in S705. In S712, the editing unit 403 executes processing of editing the proxy movie file to generate an edited movie based on an instruction of the editor, and the editing information file generation unit 404 updates the editing information file 500. In S713, processing of transmitting the state of the editing processing in S712 to the movie recording apparatus 102 is executed. The detail will be described later. In S714, the movie file reception unit 401 receives the high-quality movie file transmitted from the movie recording apparatus 102 in S707.

### Update Processing of Transmission Order of High-quality Movie

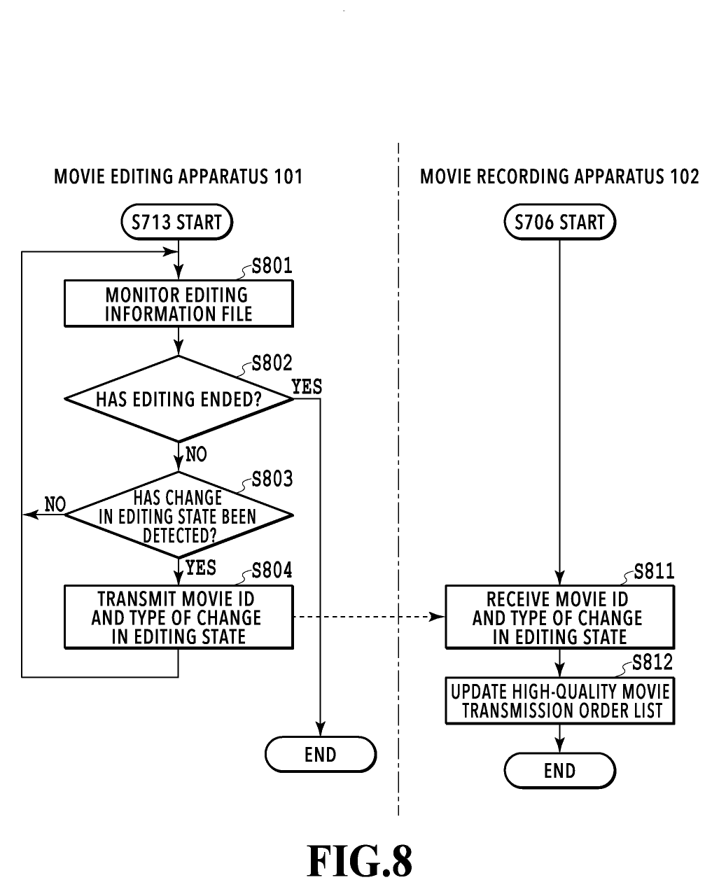

FIG. 8 is a flowchart for explaining an operation of the movie editing apparatus 101 in movie editing using proxy movie files and processing of updating a high-quality movie transmission order list in conjunction with the movie editing.

The processing from S801 to S804 of FIG. 8 are steps showing a detail of the processing of S713 which is executed in the movie editing apparatus 101.

In S801, the editing state change detection unit 405 of the movie editing apparatus 101 monitors whether or not there is a change in the editing state indicated by the editing information file 500.

In S802, the editing state change detection unit 405 determines whether or not the movie editing by the editor has ended. As the method for determining whether or not the movie editing has ended, for example, there is a method which determines that the movie editing has ended if detection is made to the effect that the editing information file 500 is deleted, or replacement from a proxy movie file to a high-quality movie file is executed.

If the editing state change detection unit 405 determines that the movie editing has ended (YES in S802), the flowchart of FIG. 8 is ended, and if not (NO in S802), the processing is advanced to S803.

In S803, the editing state change detection unit 405 determines whether or not a change in the editing state has been detected from the editing information file 500. If the editing state change detection unit 405 determines that a change in the editing state has been detected (YES in S803), the processing is advanced to S804, and if not (NO in S803), the processing is returned to S801.

In S804, the editing state change transmission unit 406 transmits the type of the change in the editing state detected in S803 and a movie ID indicating the proxy movie file in which the change in the editing state has occurred to the movie recording apparatus 102.

S811 to S812 are steps showing a detail of S706 executed in the movie recording apparatus 102.

In S811, the editing state change reception unit 414 receives the type of the change in the editing state and the movie ID transmitted from the movie editing apparatus 101 in S804.

In S812, the transmission order determination unit 415 changes the value of "Transmission priority factor flag" associated with the movie ID obtained in S811 in the high-quality movie transmission order list 600. Then, the transmission order determination unit 415 changes the transmission priority based on the value of "Transmission priority factor flag" after the change to update the high-quality movie transmission order list 600.

Here, a specific example of the update processing of the high-quality movie transmission order list 600 will be described.

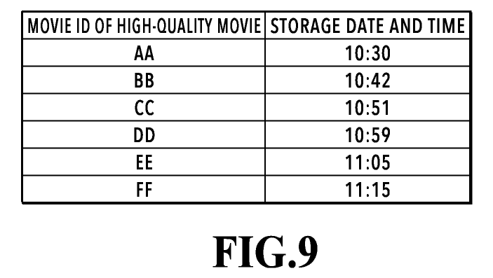

FIG. 9 is a diagram for explaining states of high-quality movie files recorded in the movie recording apparatus 102. As shown in FIG. 9, it is assumed that in the movie recording apparatus 102, six high-quality movie files whose movie IDs are "AA", "BB", "CC", "DD", "EE", and "FF", respectively, which have not been transmitted yet are recorded. In addition, it is assumed that proxy movie files corresponding to these high-quality movie files have been transmitted to the movie editing apparatus 101.

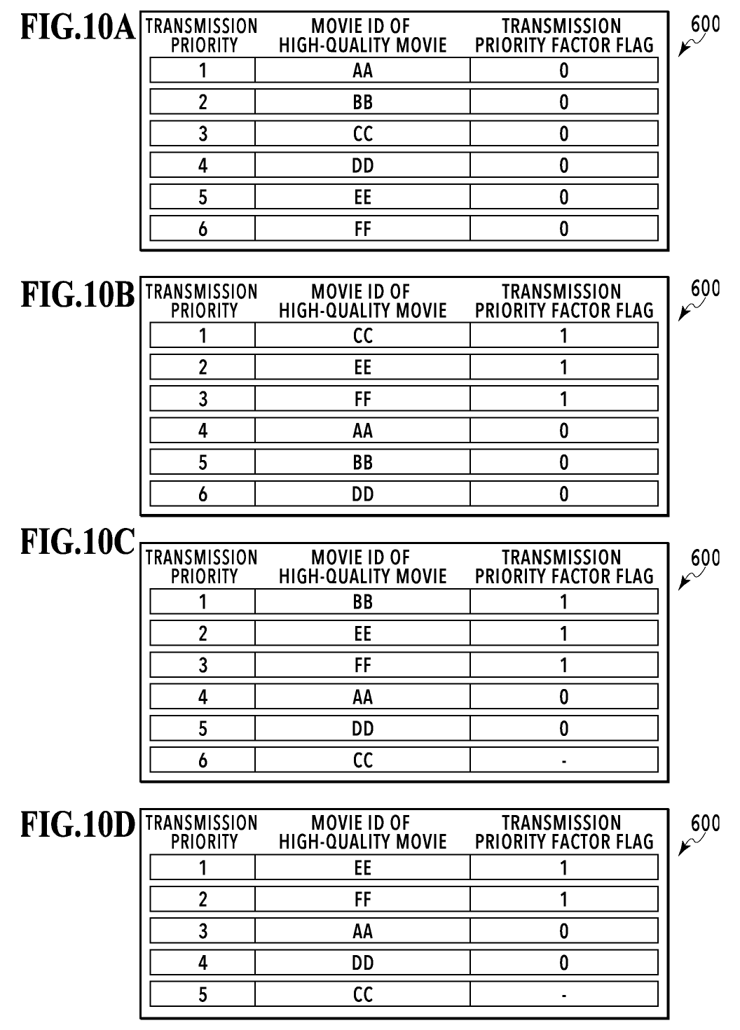

FIGS. 10A to 10D are diagrams for explaining the high-quality movie transmission order list 600 stored in the movie recording apparatus 102. Immediately after a proxy movie file is transmitted, editing has not been conducted in the movie editing apparatus 101. For this reason, as shown in FIG. 10A, values of "Transmission priority factor flag" of all the high-quality movie files are "0" which indicates that editing has not been conducted. The transmission priority is determined by the FIFO method. For this reason, the high-quality movie transmission order list 600 as shown in FIG. 10A is generated such that the high-quality movie files are sequentially transmitted in ascending order of time of storage.

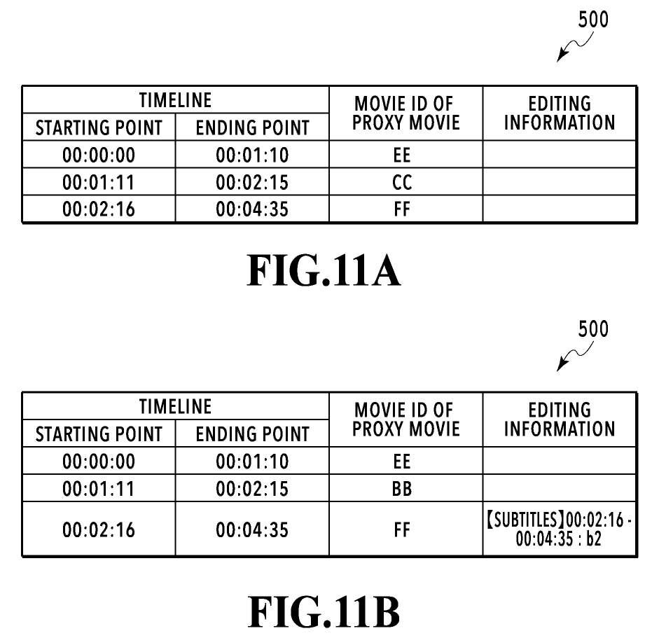

FIGS. 11A and 11B are diagrams for explaining the editing information files 500 stored in the movie editing apparatus 101. It is assumed that the editing information file 500 as shown in FIG. 11A is generated because the editor has operated the movie editing apparatus 101, so that proxy movie files whose movie IDs are "CC", "EE", and "FF" have been used in editing in the movie editing apparatus 101. In this case, in the movie editing apparatus 101, in S803, the editing state change detection unit 405 detects the change in the editing state. In S804, the editing state change transmission unit 406 transmits "EE", "CC", and "FF", which are movie IDs of the proxy movie files in which editing has been conducted, and "Addition of movie ID" as the type of the change in the editing state of each proxy movie file to the movie recording apparatus 102.

In the movie recording apparatus 102, in S811, the editing state change reception unit 414 receives "EE", "CC", and "FF", which are the movie IDs, and "Addition of movie ID" as the type of the change in the editing state. In S812, the transmission order determination unit 415 changes values of "Transmission priority factor flag" of "EE", "CC", and "FF", which are movie IDs received in S811, from "0" to "1" in the high-quality movie transmission order list 600. Then, the transmission order determination unit 415 makes the transmission priority of the movie file whose value of "Transmission priority factor flag" is "1" higher than the transmission priority of the movie file whose value of "Transmission priority factor flag" is "0", and rearranges those whose Transmission priority factor flags are "1" by the FIFO method. As a result, the high-quality movie transmission order list 600 is updated as shown in FIG. 10B.

It is assumed that the editor thereafter operates the movie editing apparatus 101 to conduct such editing as adding information to "Editing information" in "FF" whose movie ID has already been added. Moreover, it is assumed that the editor operates the movie editing apparatus 101 to conduct such editing as quitting the use of the proxy movie file of "CC" and generating an edited movie by using the proxy movie file of "BB" instead. As a result, the editing information file 500 is updated as shown in FIG. 11B.

In this case, in S804, the editing state change transmission unit 406 transmits "FF", which is the movie ID of the proxy movie file for which the information has been added to "Editing information", and the type of the change in the editing state thereof which is "Addition of editing information" to the movie recording apparatus 102. In addition, the editing state change transmission unit 406 transmits "CC", which is the movie ID of the proxy movie file which has been disused for the edited movie, and the type of the change in the editing state thereof which is "Deletion of movie ID" to the movie recording apparatus 102. The editing state change transmission unit 406 transmits "BB", which is the movie ID of the proxy movie file newly used for the edited movie, and the type of the change in the editing state thereof which is "Addition of movie ID" to the movie recording apparatus 102.

In the movie recording apparatus 102, in S811, the editing state change reception unit 414 receives the movie ID and the type of the change in the editing state. Then, in S812, the transmission order determination unit 415 changes "Transmission priority factor flag" from "1" to "-" for the movie ID "CC" whose type of the change in the editing state is "Deletion of movie ID". For the movie ID "BB", which has been received, since the type of the change in the editing state thereof is "Addition of movie ID", the transmission order determination unit 415 changes the Transmission priority factor flag of the movie ID "BB" from "0" to "1".

Then, the transmission order determination unit 415 makes the transmission priority of the movie file whose transmission priority factor flag is "1" higher than the transmission priority of the movie file whose transmission priority factor flag is "0", and rearranges the movie files whose transmission priority factor flags are "1" by the FIFO method. In addition, in the case where a movie ID has been deleted, in order to make the transmission priority of the movie ID thus deleted lowest, the transmission order determination unit 415 makes the transmission priority of the movie ID whose transmission priority factor flag is "-" lowest. As a result, the high-quality movie transmission order list 600 is updated as shown in FIG. 10C.

Note that it can be considered that the effect that "Addition of editing information" is detected as the type of the change in the editing state because subtitles are added or a BGM is added to a timeline means that the editing on the proxy movie file corresponding to the timeline is relatively nearing completion. That is, it can be considered that the detection of "Addition of editing information" means that there is a low possibility that the corresponding proxy movie file is deleted from the edited movie. Hence, in S812, the transmission order determination unit 415 may determine the transmission orders such that the transmission order of a high-quality movie file indicated by a movie ID corresponding to "Addition of editing information" becomes higher than the high-quality movie file corresponding to "Addition of movie ID". For example, in the case where the editing information file 500 is updated as shown in FIG. 11B, the high-quality movie transmission order list 600 may be updated such that the transmission priority of a high-quality movie file whose movie ID is "FF" for which information has been added to "Editing information" becomes "1".

In addition, regarding a high-quality movie file which is currently being transmitted to the movie editing apparatus 101, even in the case where the transmission order determination unit 415 has changed the transmission priority in S812, the transmission may not be stopped. In addition, whether or not to stop the transmission may be determined depending on a high-quality movie file being transmitted. For example, in the case where the value of "Transmission priority" of the high-quality movie file being transmitted is "1", it may be determined not to stop the transmission. Or, in the case where the high-quality movie file being transmitted is a movie file based on a transmission instruction manually made by the videographer, it may be determined not to stop the transmission.

Whether or not to stop the transmission may be determined based on an instruction of the videographer. For example, transmission orders indicated by the high-quality movie transmission order list 600 and a message screen such as "Do you want to stop the transmission of the movie AA being transmitted, and transmit the movie CC?" may be displayed on the display unit 218 of the movie recording apparatus 102. Then, in the case where the videographer has conducted an operation of instructing the stop of transmission, the transmission may be stopped.

### High-quality Movie File Transmission Processing

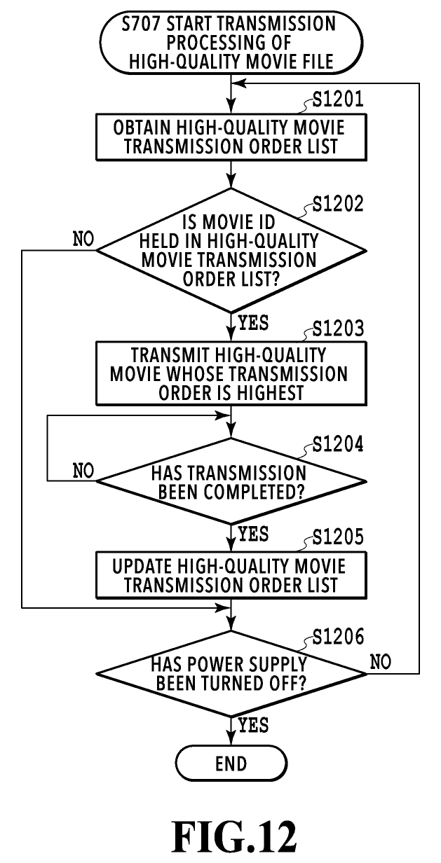

FIG. 12 is a flowchart for explaining a detail of transmission processing of a high-quality movie file.

In S1201, the movie file transmission unit 413 obtains a high-quality movie transmission order list 600. As mentioned above, since the high-quality movie transmission order list 600 is updated as needed, in S1201, the high-quality movie transmission order list 600 after update is obtained.

In S1202, the movie file transmission unit 413 determines whether or not at least one movie ID is held in the high-quality movie transmission order list 600 obtained in S1201. If the movie file transmission unit 413 determines that a movie ID is held (YES in S1202), the processing is advanced to S1203, and if not (NO in S1202), the processing is advanced to S1206.

In S1203, the movie file transmission unit 413 searches the high-quality movie files managed by the movie file management unit 412 for a high-quality movie file which corresponds to a movie ID whose transmission priority is "1" in the high-quality movie transmission order list 600. Then, the movie file transmission unit 413 transmits a high-quality movie file which corresponds to the movie ID whose transmission priority is "1" to the movie editing apparatus 101.

In S1204, the movie file transmission unit 413 determines whether or not the transmission of the high-quality movie file has been completed. If the movie file transmission unit 413 determines that the transmission has been completed (YES in S1204), the processing is advanced to S1205, and if not (NO in S1204), S1204 is repeated.

In S1205, the movie file transmission unit 413 deletes the movie ID indicating the high-quality movie file the transmission of which has been completed from the high-quality movie transmission order list 600, and heightens the transmission priorities of the other movie IDs by one.

For example, in the case where the high-quality movie transmission order list obtained in S1201 is of FIG. 10C, in S1203, a high-quality movie file whose movie ID is "BB" and whose transmission priority is "1" is transmitted to the movie editing apparatus 101. Then, once the transmission is completed, in S1205, the high-quality movie transmission order list 600 is updated as shown in FIG. 10D.

In S1206, the movie file transmission unit 413 determines whether or not the power supply of the movie recording apparatus 102 has been turned OFF. If the movie file transmission unit 413 determines that the power supply has been turned OFF (YES in S1206), the flowchart of FIG. 12 is ended, and if not (NO in S1206), the processing is returned to S1201.

In the movie editing apparatus 101 which has received a high-quality movie file, the high-quality movie file is stored in the storage medium 206 or the like. Then, the editing has been ended in the movie editing apparatus 101, processing of replacing proxy movies in the edited movie with high-quality movies is conducted to generate a high-quality edited movie for use in broadcast or the like.

As described above, according to the present embodiment, the order in which the movie recording apparatus 102 transmits high-quality movie files can be rearranged as appropriate even in a situation in which proxy movie files to be edited are dynamically rearranged on the movie editing apparatus 101 side. There is a case where once the generation of an edited movie using proxy movie files is completed, the editor wants to swiftly obtain high-quality movies corresponding to the proxy movies used for the edited movie, and conduct the subsequent work. In this case, according to the present embodiment, high-quality movie files which the editor requires are preferentially transmitted without communication between the editor and the videographer over telephones or the like. For this reason, transmission of movies between a movie editing apparatus on the broadcasting station side and a movie recording apparatus on the coverage site can be efficiently conducted.

Note that the above description is made such that the transmission order determination unit 415 is included in the movie recording apparatus 102, and the transmission order of a high-quality movie file is determined in the movie recording apparatus 102. Alternatively, the determination of a transmission order may be made in the movie editing apparatus 101. For example, the transmission order list management unit 416 and the transmission order determination unit 415 in FIG. 4 may be included in the movie editing apparatus 101. Then, a configuration in which the movie editing apparatus 101 determines a transmission order of a high-quality movie file, and transmits the transmission order thus determined to the movie recording apparatus 102, and the movie recording apparatus 102 transmits a high-quality movie file to the movie editing apparatus 101 in accordance with the transmission order thus received may be employed. In this case, the processing of S811 and S812 in FIG. 8 is conducted in the movie editing apparatus 101.

In addition, a configuration in which the frequency at which a change in the editing state is detected by the editing state change detection unit 405 is lowered may be employed. For example, in the case where a value was added to the "Movie ID of the proxy movie" column of an editing information file 500, and the value has not been deleted for a predetermined period of time, it can be considered that there is a high possibility that a proxy movie file indicated by the movie ID will be used in an edited movie. In addition, in the case where after a value was deleted from the "Movie ID of the proxy movie" column of an editing information file, and the value of movie ID which was deleted has not been added again even after the elapse of a predetermined period of time, it can be considered that there is a high possibility that the proxy movie file of the value of movie ID will not be used in an edited movie. Hence, a configuration in which in the case where the editing state change detection unit 405 of the movie editing apparatus 101 detects a change in the editing state in S803, if the editing state after the update is maintained for a predetermined period of time, the editing state change detection unit 405 determines that the change in the editing state has been detected may be employed. For example, in the case where a deleted movie ID has not been added again even after the elapse of a predetermined period of time, the editing state change detection unit 405 may detect "Deletion of movie ID". By conducting the processing in this way, it becomes possible to suppress notification to the movie recording apparatus 102 and the frequency at which the transmission order of a high-quality movie file is changed.

In addition, the above-mentioned information processing system has been described to have the configuration including the movie editing apparatus 101 and the movie recording apparatus 102, in which each functional unit of the movie editing apparatus 101 shown in FIG. 4 is operated inside the movie editing apparatus 101. The configuration is not limited to this, and the movie editing apparatus 101 and the movie recording apparatus 102 may be connected to an outside server so that some or all functions of the movie editing apparatus 101 shown in FIG. 4 are included in an outside server and operated. For example, the information processing system shown in FIG. 1 may include a plurality of servers instead of the movie editing apparatus 101. Then, the functions included in the movie editing apparatus 101 shown in FIG. 4 may be implemented by the plurality of servers operating in a shared manner.

At a site of video creation, there are cases where a movie for material which has been supposed to be used for editing will not be used at short notice, and a movie for material which has not been supposed to be used for editing will be used at short notice. In the case where a movie for material to be used in editing is changed, it is demanded to change transmission orders of high-quality movies such that a high-quality movie corresponding to a movie for material which becomes to be used in editing will be first transmitted to a video editing apparatus. However, if transmission orders of high-quality movies are to be changed in accordance with the method of International Publication No. 2015/097922, the user is required to check the editing state in the video editing apparatus as needed, and repeat operations of manually canceling generated transmission orders and instructing the generation of transmission order again in accordance with a change in the editing state. For this reason, burdens for the user may occur, leading to a possibility that the transmission of movies cannot be efficiently conducted.

According to the technology of the present disclosure, the transmission of movies can be efficiently conducted.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-189752, filed October 29,2024, which is hereby incorporated by reference herein in its entirety.

What is claimed is:

1. An information processing apparatus comprising:
one or more memories storing instructions; and
one or more processors executing the instructions to:
receive a plurality of second movies from a movie recording apparatus configured to record a plurality of first movies, wherein each of the plurality of first movies corresponds to one of the plurality of second movies and an image quality of the second movie is lower than an image quality of the first movie;
generate a third movie by editing based on the received second movie;
transmit information indicating a state of the editing to the movie recording apparatus; and
receive the first movie transmitted from the movie recording apparatus in accordance with transmission orders determined based on the transmitted information.

2. The information processing apparatus according to claim 1, wherein
the third movie is generated by using the second movie selected from the plurality of the second movies and
the transmitted information includes information indicating the second movie which is used for generating the third movie.

3. The information processing apparatus according to claim 2, wherein
the transmitted information includes information indicating the second movie which was used before but is disused for the third movie.

4. The information processing apparatus according to claim 1, wherein
the one or more processors further execute the instructions to detect a change in the state of the editing, and
in a case where the change is detected, the information is transmitted.

5. The information processing apparatus according to claim 4, wherein
the one or more processors further execute the instructions to generate editing information to manage the state of the editing, and
in a case where a character indicating editing is added in the editing information, the change is detected.

6. The information processing apparatus according to claim 5, wherein
in a case where an updated state maintained in the editing information for a predetermined period of time, the change is detected.

7. The information processing apparatus according to claim 1, wherein
the one or more processors further execute the instructions to determine the transmission orders of the first movies based on the state of the editing, and
the transmission order is transmitted to the movie recording apparatus as the transmitted information so that the movie recording apparatus transmits the first movies in accordance with the determined transmission orders.

8. A movie recording apparatus comprising:
one or more memories storing instructions; and
one or more processors executing the instructions to:
record a plurality of first movies;
generate a plurality of second movies, wherein each of the plurality of first movies corresponds to one of the plurality of second movies and an image quality of the second movie is lower than an image quality of the first movie;
transmit the plurality of second movies to an information processing apparatus configured to generate a third movie by editing based on the second movie;
receive information indicating a state of the editing from the information processing apparatus;
determine transmission orders of the first movies based on the received information; and
transmit the first movies to the information processing apparatus in accordance with the determined transmission orders.

9. The movie recording apparatus according to claim 8, wherein
the transmission orders are determined such that the first movie corresponding to the second movie which is used for generating the third movie is transmitted prior to the first movie corresponding to the second movie which is not used for generating the third movie.

10. The movie recording apparatus according to claim 9, wherein the one or more processors further execute the instructions to change the transmission orders such that the first movie corresponding to the second movie which was used before but is disused for generating the third movie is transmitted later than the first movie corresponding to the second movie which is used for generating the third movie.

11. The movie recording apparatus according to claim 9, wherein the one or more processors further execute the instructions to change the transmission orders such that the first movie corresponding to the second movie which is used for generating the third movie and on which predetermined editing has been conducted is transmitted prior to the other first movies

12. The movie recording apparatus according to claim 11, wherein
the predetermined editing is editing to add subtitles, or editing to add a BGM.

13. The movie recording apparatus according to claim 8, wherein the one or more processors further execute the instructions to capture movies for obtaining the first movies.

14. An information processing method comprising:
receiving a plurality of second movies from a movie recording apparatus configured to record a plurality of first movies, wherein each of the plurality of first movies corresponds to one of the plurality of second movies and an image quality of the second movie is lower than an image quality of the first movie;
generating a third movie by editing based on the received second movie;
transmitting information indicating a state of the editing to the movie recording apparatus; and
receiving the first movie transmitted from the movie recording apparatus in accordance with transmission orders determined based on the transmitted information.
